(19) United States
(12) Patent Application Publication
(10) Pub. No.: US 2021/0122142 A1
(43) Pub. Date: Apr. 29, 2021

(54) LIGHT WEIGHT FIRE RESISTANT SMC COMPOSITION

(71) Applicants: Jeffrey R. ROBBINS, Ann Arbor, MI (US); Magna Exteriors Inc., Concord (CA)

(72) Inventors: Jeffrey R. Robbins, Ann Arbor, MI (US); Ranjit Pachha, Brampton (CA)

(73) Assignee: Magna Exteriors Inc., Concord, ON (CA)

(21) Appl. No.: 17/252,832

(22) PCT Filed: Jul. 11, 2019
(86) PCT No.: PCT/US2019/041381

§ 371 Date: Dec. 16, 2020

Related U.S. Application Data
(60) Provisional application No. 62/696,608, filed on Jul. 11, 2018.
(60) Provisional application No. 62/696,612, filed on Jul. 11, 2018.

(51) Int. Cl. B32B 17/02

(52) U.S. Cl. CPC B32B 17/02; B32B 2307/3065; B32B 2307/718; B32B 2262/101; B32B 2313/04; B32B 2439/62; B32B 2311/24

(57) ABSTRACT

A flame retardant SMC composition comprising an effective amount of flame retardant graphene material provided in an SMC composition for providing a flame retardancy with a specific gravity of less than or equal to 1.8.

### FIELD OF THE INVENTION

The present invention relates to light weight fire resistant SMC composition.

### BACKGROUND OF THE INVENTION

Sheet molding compositions are useful as housings and bodies of many items. Furnaces, vehicle panels and consumer goods are made from such compositions.

Flammability of in home environments have been subject to many regulations and materials which have been developed to reduce flammability of such items. It has been found that aluminum trihydrate (ATH) is added as a filler in relatively high concentrations for controlling flammability of such SMC structures.

With the advent of electric vehicles, banks of batteries are required for powering the vehicles. The batteries are required to be housed in a box or some sort of container within the vehicle. Typically a light aluminum material is used because it does not burn. However, aluminum does get brittle after a raised temperature event and does have a fairly low melting point and cannot withstand temperatures over 680 degrees Centigrade plus these materials are conductive and as such are not the best selection for batteries storing electricity potential. Thus, using a material such as an SMC material as a substitute is desirable.

There has been a new standard created which any material used in a vehicle must maintain. Currently the materials must withstand minimal burning for 130 seconds when subjected to a gasoline fire of 960 degrees Centigrade. SMC when highly loaded with ATH can withstand this flammability test. However, materials with the proper amount of ATH become heavy typically above specific gravity of 2. Plus, the high quantities of ATH required to meet the proper standard reduces the mechanical properties of the SMC enough to make it prohibitive to manufacture and use.

Therefore it is a desired to provide a relatively light weight SMC composition useful in flame retardant applications such as a battery box of an electric vehicle.

### SUMMARY OF THE INVENTION

In accordance with the present invention there is provided a light weight flame retardant SMC composition. The flame retardant SMC material includes an effective amount of flame retardant graphene material provided in an SMC composition for providing a flame retardancy with a specific gravity of less than or equal to 1.8.

A layer of effective flame retardant material comolded, overmolded or adhesively joined with SMC providing a flame retardant moldable laminate.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 shows a line useful for manufacturing the present SMC composition.

### DETAILED DESCRIPTION OF THE PREFERRED EMBODIMENTS

The following description of the preferred embodiment(s) is merely exemplary in nature and is in no way intended to limit the invention, its application, or uses.

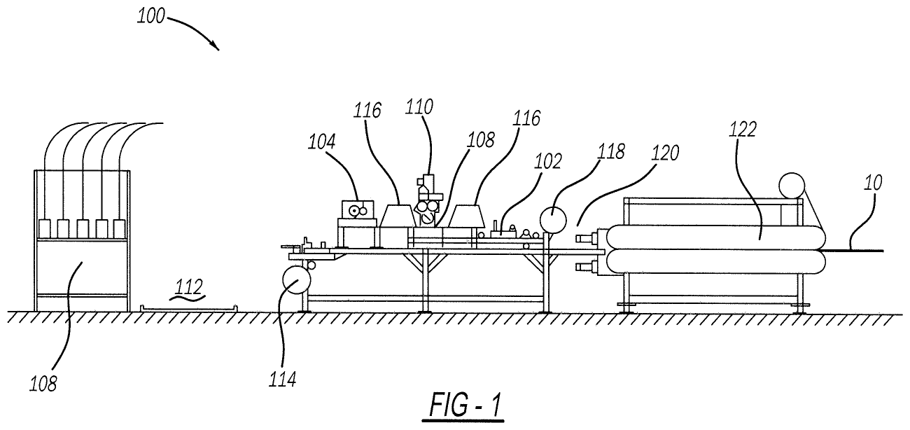

Referring to FIG. 1, there is shown a typical compounding line layout which is useful in preparing the flame retardant laminates of the present application. The compounding layout shown generally at 100 in FIG. 1. The line shown is for compounding a glass and carbon fiber reinforced SMC laminate and can be used for addition of the flame retardant material at the doctor box 102. It will be readily appreciated by those skilled in the art that the flame retardant materials could also be added elsewhere or mixed in with the carbon fiber or glass fillers as they are chopped and cut in the glass cut box 104 or carbon cut box 106. The laminate line as an example includes a carbon creel 108 which is connected to the compressed air and carbon fiber inlet 110. A space for a glass fiber creel is also provided at 112 for glass reinforcement as necessary. A first film unwind is provided at 114 and vacuum exhausts at 116. A second film unwind is provided at 118. There is a pre-compactor and de-aeration chamber provided at 120 prior to the laminate entering the compactor 122 the final SMC fire retardant laminate 10 exits the compounding line and is wound on an automatic winder. As will be appreciated the entire line is temperature controlled during the compounding process.

A flame retardant SMC composition comprising an effective amount of flame retardant graphene material provided in an SMC composition for providing a flame retardancy with a specific gravity of less than or equal to 1.8. A layer of effective flame retardant material comolded, overmolded or adhesively joined with SMC providing a flame retardant moldable laminate. Preferably the resulting laminate has a specific gravity of less than or equal to 1.8 and can withstand the ASTM E-84 standards for flame retardancy.

The flame retardant SMC composition wherein the material complies with the ASTM E-84 standards for flame retardancy.

The effective amount of graphene material is provided in said SMC in an amount of from about 0.1% to about 10% by volume in the SMC with the remainder SMC fillers and reinforcement elements. Preferably the graphene is provided in an amount of from about 0.2% to about 5.0% by volume.

SMC compositions useful in the present invention are preferably a vinyl ester based SMC which are long glass fiber reinforced with 0.5 to 1.5 inch glass fibers and preferably about 1 inch glass fibers. Generally the SMC includes 20%-30% glass fibers and typically about 25% to about 28% glass fibers. However, unsaturated polyesters, phenolics, polyurethanes and epoxy resins can also be used.

It is within the scope of the present invention that ATH is to be included in the composition provided handling and mechanical properties of the SMC resin may be maintained and provided the resulting composition maintains a specific gravity of less than or equal to 1.8. Using ATH in the composition at levels which raise the specific gravity of the final compound above 1.8 would detrimentally affect the properties of the present invention.

The graphene may or may not be functionalized. Graphene having functional groups like COON (carboxyl) may be used to achieve chemical bonding with the resin resulting in better mechanical properties of the sheet molding composition (SMC).

The SMC material of the present invention comply with the ASTM E-84 standards for flame retardancy and are also able to withstand the gasoline burn tests of withstanding 960 degrees Centigrade for 130 seconds.

SMC compositions are useful for battery boxes in an electric vehicle in that even if exposed to a fire, properties are maintained and useful life remains. This is an improvement over aluminum boxes where if exposed to high heat they may either melt away or mechanical properties are severely diminished requiring replacement.

### EXAMPLE 1

The layers of effective amount of flame retardant material are made from a graphene containing SMC material, a woven graphene embedded mat material, some of the tests include amounts of ATH which do not result in a specific gravity above 1.8. These SMC compounds are used using the laminate production line. These materials are assembled using woven mats of materials between SMC layers and also as a separate layer. Individually laid fibers, chopped fibers, powders and pulps of these materials are also used.

The SMC and materials manufactured are found to comply with the ASTM E-84 standards for flame retardancy. The materials are tested and are found to maintain a specific gravity of less than or equal to 1.8.

### EXAMPLE 2

A laminate a layer of a graphene containing light weight fire retardant material is prepared using 0.1%, 0.2%, 5.0%, 10% by volume graphene with the balance SMC and fillers. The balance of the compound is fillers which do not affect the specific gravity limitations or flame retardancy of the composition. This layer is applied to a standard SMC composition and also sandwiched between SMC layers. The compound is found to be flame retardant as required by the ASTM E-84 standards for flame retardancy. The materials are tested and are found to maintain a specific gravity of less than or equal to 1.8.

SMC compositions used are vinyl ester based SMC's which are long glass fiber reinforced with 0.5, 1, and 1.5 inch glass fibers. The SMC's used include 20%, 25%, 28% and 30% glass fibers. Tests are made using unsaturated polyesters and epoxy resins also in the above amounts with and without fillers. This material is tested and meets the ASTM E-84 Standards for flame retardancy. The materials are tested and are found to maintain a specific gravity of less than or equal to 1.8.

The description of the invention is merely exemplary in nature and, thus, variations that do not depart from the essence of the invention are intended to be within the scope of the invention. Such variations are not to be regarded as a departure from the spirit and scope of the invention.

Further understanding of flame retardant SMC laminates will be acquired in reference to my co-pending application filed on the same date as this application entitled “FIRE RESISTANT SMC LAMINATE,” claiming priority to U.S. Provisional Ser. No. 62/696,612, filed Jul. 11, 2018, Attorney Docket No. DEC-00368-PCA (711378PCT), the entire contents of which are expressly incorporated by reference herein.

What is claimed is:

1. A flame retardant SMC composition comprising:
an effective amount of flame retardant graphene material comolded, overmolded or adhesively joined with SMC in an SMC composition for providing a flame retardancy with a specific gravity of less than or equal to 1.8.

2. The flame retardant SMC composition of claim 1 wherein the material complies with the ASTM E-84 standards for flame retardancy.

3. The flame retardant SMC composition of claim 1 wherein the effective amount of graphene material is provided in said SMC in an amount of from about 0.1% to about 10% by volume in the SMC with the remainder SMC.

4. The flame retardant SMC composition of claim 3 wherein the graphene is provided in an amount of from about 0.2% to about 5% by volume.

5. The flame retardant SMC composition of claim 4 wherein the graphene includes COOH (carboxyl) functional groups which provides mechanical strengthening of the SMC.

6. The flame retardant SMC composition of claim 1 which also includes and effective amount of aluminum trihydrate that provides flame retardancy without adding weight to exceed a specific gravity of greater than 1.8.

7. A battery box of an electric vehicle comprising an enclosure for containing an electric vehicle battery wherein at least a portion of the battery box includes a flame retardant SMC composition comprising:
an effective amount of flame retardant graphene material comolded, overmolded or adhesively joined with an SMC composition for providing a flame retardancy with a specific gravity of less than or equal to 1.8.

8. The battery box of claim 7 wherein the material complies with the ASTM E-84 standards for flame retardancy.

9. The battery box of claim 7 of claim 1 wherein the effective amount of graphene material is provided in said SMC in an amount of from about 0.1% to about 10% by volume in the SMC with the remainder SMC.

10. The battery box of claim 9 wherein the graphene is provided in an amount of from about 0.2% to about 5.0% by volume.

11. The battery box of claim 10 wherein the graphene includes COOH (carboxyl) functional groups which provides mechanical strengthening of the SMC.

12. The battery box of claim 7 comprising minor amounts of aluminum trihydrate without raising the specific gravity above 1.8.
